(19) United States
(12) Patent Application Publication
(10) Pub. No.: US 2020/0388145 A1
(43) Pub. Date: Dec. 10, 2020

(54) SENSING DEVICE, RECOVERING APPARATUS FOR RECOVERING THE SAME, AND DISCARDING APPARATUS FOR DISCARDING THE SAME

(71) Applicant: SONY CORPORATION, TOKYO (JP)

(72) Inventor: SHINYA MARUYAMA, KANAGAWA (JP)

(21) Appl. No.: 16/770,370

(22) PCT Filed: Oct. 1, 2018
(86) PCT No.: PCT/JP2018/036664

§ 371 Date: Jun. 5, 2020

(30) Foreign Application Priority Data
Jan. 17, 2018 (JP) 2018-005443

(51) Int. Cl. G08B 25/10; H04M 11/04; G08C 17/02

(52) U.S. Cl. CPC G08B 25/10; G08C 17/02; H04M 11/04

(57) ABSTRACT

Recovery of deployed devices that are no longer needed is promoted. A sensing device (IoT device) having a sensor function includes a sensor, a sensing section, a transmitting section, and a recovery reporting section. The sensor measures a surrounding environment. The sensing section senses occurrence of a predetermined event. The transmitting section transmits measurement results of the sensor until the occurrence of the predetermined event is sensed. When the occurrence of the predetermined event is sensed, the recovery reporting section reports recovery information indicating that the own device is targeted for recovery.

### TECHNICAL FIELD

The present technology relates to a sensing device. More particularly, the technology relates to a sensing device that transmits measurement results by wireless communication, a recovering apparatus for recovering the sensing device, and a discarding apparatus for discarding the sensing device.

### BACKGROUND ART

With the arrival of an era of IoT (Internet of Things), IoT devices having a wireless communication function are spreading rapidly. As one application example of the IoT devices, there has been proposed a disaster prevention system that includes multiple terminals and a control apparatus, each of the terminals making observations using sensors and transmitting observed sensor information by wireless communication, the control apparatus predicting a disaster on the basis of the sensor information (e.g., see PTL 1).

### CITATION LIST

### Patent Literature

### [PTL 1]

Japanese Patent Laid-Open No. 2017-091440

### SUMMARY

### Technical Problem

According to the above existing technology, multiple terminals with a sensor function (IoT devices) are deployed to collect sensor information. As the deployed IoT devices grow in number from now on, it becomes necessary to recover the IoT devices that are no longer needed. If left abandoned, the IoT devices will pose problems such as privacy issues of data stored in the devices, effects of the abandoned devices on the environment, and straining of bandwidths due to useless radio waves from the devices.

The present technology has been devised in view of the above circumstances and aims at promoting the recovery of deployed devices that are no longer needed.

### Solution to Problem

The present technology is aimed at solving the above problem. According to a first aspect of the technology, there is provided a sensing device including: a sensor configured to measure a surrounding environment; a sensing section configured to sense occurrence of a predetermined event; a transmitting section configured to continuously transmit measurement results of the sensor until the occurrence of the predetermined event is sensed; and a recovery reporting section configured such that when the occurrence of the predetermined event is sensed, the recovery reporting section reports recovery information indicating that the device is targeted for recovery. This provides an effect of reporting the recovery information indicating that the device is targeted for recovery when the occurrence of the predetermined event is sensed.

Also, according to the first aspect of the present technology, the sensing section may sense the predetermined event upon receipt of a discard signal from another device. This provides an effect of reporting the recovery information in response to the discard signal from another device.

Also, according to the first aspect of the present technology, the sensing section may sense the predetermined event on the basis of a change in an environment of the device. This provides an effect of reporting the recovery information on the basis of a change in the environment of the device.

Also, according to the first aspect of the present technology, the sensing section may sense the change in the environment of the device on the basis of measurement results of the sensor. This provides an effect of reporting the recovery information on the basis of the measurement results of the sensor.

Also, according to the first aspect of the present technology, the sensing device may further include a recovery information retaining section configured to retain the recovery information. This provides an effect of retaining a recording to the effect that the device is targeted for recovery.

Also, according to the first aspect of the present technology, the sensing device may further include a security managing section configured to perform secure writing to the recovery information retaining section. This provides an effect of improving the security of the recovery information retained by the recovery information retaining section.

Also, according to the first aspect of the present technology, the security managing section may write the recovery information signed with a signature key to the recovery information retaining section. This provides an effect of preventing falsification of the recovery information retained by the recovery information retaining section.

Also, according to the first aspect of the present technology, the sensing device may further include a clocking section configured to clock the time. The recovery information retaining section may retain the clocked time as the recovery information. This provides an effect of allowing the recovery information retained by the recovery information retaining section to be investigated retroactively.

Also, according to the first aspect of the present technology, the sensing device may further include a position sensing section configured to sense the position of the device. The transmitting section may transmit the position sensed by the position sensing section together with the measurement results of the sensor. This provides an effect of sensing a failure in keeping with the position of the device.

Also, according to the first aspect of the present technology, the recovery reporting section may report the recovery information signed with the signature key. This provides an effect of preventing falsification of the reported recovery information.

According to a second aspect of the present technology, there is provided a recovering apparatus including: a recovery information receiving section configured to receive from a sensing device a report of recovery information indicating that the sensing device is targeted for recovery; and a recovery information verifying section configured to verify that the recovery information has not been falsified by use of a signature verification key. This provides an effect of securely identifying the sensing device that is recoverable.

According to a third aspect of the present technology, there is provided a discarding apparatus including: a measurement result receiving section configured to receive measurement results of a sensor transmitted from a sensing device; and a discard signal transmitting section configured to transmit a discard signal identifying the sensing device as a recovery target upon sensing a change in an environment of the sensing device on the basis of the measurement results. This provides an effect of putting the sensing device in a recoverable state depending on the measurement results.

### Advantageous Effect of Invention

The present technology provides an advantageous effect of promoting the recovery of deployed devices that are no longer needed. It is to be noted that this and other advantageous effects outlined above are not limitative of the present disclosure. Further advantages of the disclosure will become apparent from the ensuing description.

### BRIEF DESCRIPTION OF DRAWINGS

FIG. 1 is a view depicting a typical overall configuration of a sensing system embodying the present technology.

FIG. 2 is a view depicting a typical configuration of an IoT device 100 of the embodiment of the technology.

FIG. 3 is a view depicting a first operation example of writing and verifying recovery information with the embodiment of the present technology.

FIG. 4 is a view depicting a second operation example of writing and verifying the recovery information with the embodiment of the present technology.

FIG. 5 is a view depicting a third operation example of writing and verifying the recovery information with the embodiment of the present technology.

FIG. 6 is a view depicting a first operation example of a process using deposits with the embodiment of the present technology.

FIG. 7 is a view depicting a second operation example of the process using deposits with the embodiment of the present technology.

FIG. 8 is a view depicting a third operation example of the process using deposits with the embodiment of the present technology.

### DESCRIPTION OF EMBODIMENT

One embodiment for implementing the present technology (referred to as the embodiment) is described below. The description will be given under the following order.

1. System configuration

2. Operations

3. Deposits

<1. System Configuration>

[Overall Configuration]

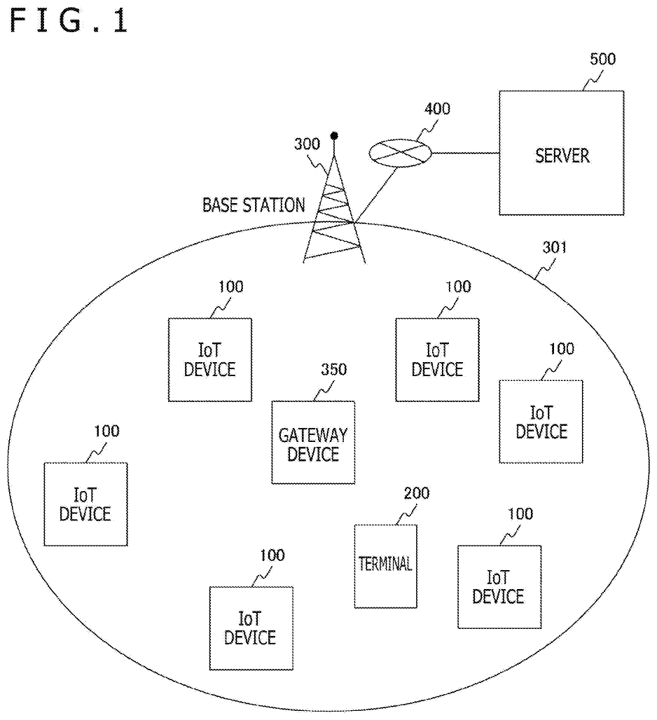

FIG. 1 is a view depicting a typical overall configuration of a sensing system embodying the present technology.

The sensing system includes multiple IoT devices 100, a base station 300, and a server 500. The IoT devices 100 and the base station 300 are interconnected by wireless communication. The base station 300 and the server 500 are interconnected via a network 400.

The IoT devices 100 are each a sensing device having a wireless communication function and a sensor function. The IoT device 100 transmits measurement results of a sensor by wireless communication. Also, the IoT device 100 retains recovery information indicating that the device is recoverable and reports the recovery information to the outside. This makes it easy to recover the IoT devices 100 that are no longer needed.

The base station 300 performs wireless communication with the IoT devices 100. This base station 300 communicates wirelessly with the IoT devices 100 that are deployed within a communication range 301. The base station 300 is connected to the server 500 via the network 400 and transmits the measurement results of the IoT devices 100 to the server 500. Also, the base station 300 relays a discard signal from the server 500 to an IoT device 100.

Preferably, a gateway device 350 may be installed interposingly in a communication path between the base station 300 on one hand and the IoT devices 100 on the other hand. Here, the gateway device 350 is a device that relays the measurement results transmitted from one or multiple IoT devices 100 to the base station 300 by wireless or wired communication. Even in a case where an IoT device 100 cannot be connected to the base station 300 via the network, the gateway device 350 is connected by wire or wirelessly to the IoT device 100 to relay the communication with the base station 300. The gateway device 350 may also relay the discard signal from the base station 300 to the IoT devices 100. The gateway device 350 may be further caused to perform data processing such as sensing of a failure in an IoT device 100, abstraction of raw data, and partial processing of machine learning. The processing is expected to provide offloading of the load of the IoT devices 100, reduction of network bandwidth, and protection of privacy by abstraction of raw data through the gateway device 350.

The server 500 manages the IoT devices 100. The server 500 is connected to the IoT devices 100 via the network 400 and receives and retains the measurement results from the IoT devices 100. Further, on the basis of the measurement results from an IoT device 100, the server 500 transmits to that IoT device 100 a discard signal identifying the IoT device 100 as a recovery target. Having received the discard signal, the IoT device 100 retains recovery information indicating that the device is recoverable. Alternatively, the IoT device 100 may retain the recovery information associated with its own determination. The details of the aspect will be discussed later.

The recovery information reported by the IoT device 100 to the outside may conceivably come in diverse forms, as will be explained later. Typically, the recovery information is expected to be transmitted to the server 500 together with sensor measurement results. Alternatively, a terminal 200 may be used to receive reports of the recovery information from nearby IoT devices 100.

[Configuration of the IoT Device]

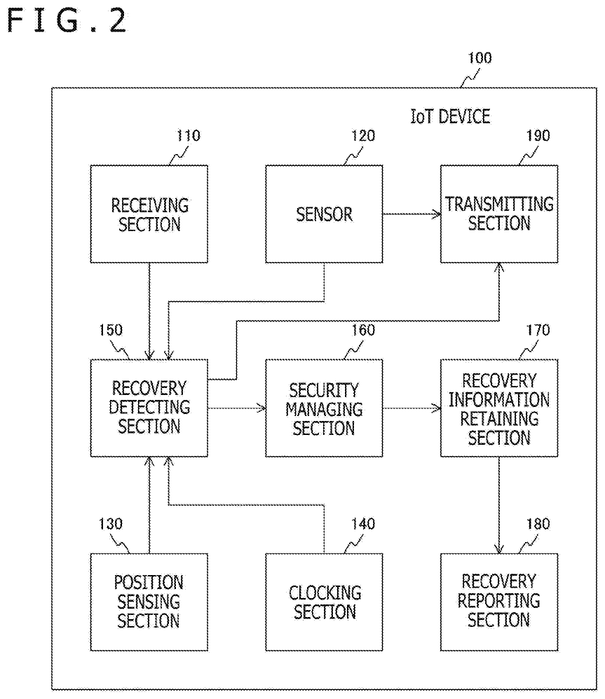

FIG. 2 is a view depicting a typical configuration of an IoT device 100 of the embodiment of the present technology.

The IoT device 100 includes a receiving section 110, a sensor 120, a position detecting section 130, a clocking section 140, a recovery detecting section 150, a security managing section 160, a recovery information retaining section 170, a recovery reporting section 180, and a transmitting section 190.

The receiving section 110 receives signals from the outside by wireless communication. The receiving section 110 receives signals from the server 500 via the base station 300 and the network 400. The signals from the server 500 include the above-mentioned discard signal.

The sensor 120 measures the surrounding environment. The sensor 120 may conceivably be a heat sensor, a temperature sensor, an image sensor, a velocity sensor, an acceleration sensor, a gyro sensor, a voice sensor, an ultrasonic sensor, or a vibration sensor, for example.

The position sensing section 130 senses position information regarding the IoT device 100. The position sensing section 130 may conceivably be a positioning sensor using a GPS (Global Positioning System), for example.

The clocking section 140 is a clock that measures the current time. The clocking section 140 may measure the current time either on the basis of a clock in the IoT device 100 or by use of time information from the above-mentioned GPS.

The recovery detecting section 150 detects that the own IoT device 100 has become recoverable by sensing the occurrence of a predetermined event. Alternatively, the recovery detecting section 150 may detect whether or not the own IoT device 100 has become recoverable on the basis of the measurement results of the sensor 120. As another alternative, the recovery detecting section 150 may detect that the own IoT device 100 has become recoverable in keeping with an instruction (discard signal) from an external apparatus such as the sensor 120. Incidentally, the recovery detecting section 150 is an example of the sensing section described in the appended claims.

The security managing section 160 is a feature that manages security when recovery information indicating that the own IoT device 100 is a recovery target is stored into the recovery information retaining section 170. At the time the recovery detecting section 150 detects that the device is recoverable, the security managing section 160 stores the recovery information into the recovery information retaining section 170. At this point, the security managing section 160 performs secure writing to protect the recovery information against falsification. The security managing section 160 also has an anti-rollback function that detects a fraudulent attempt to delete the written recovery information.

The recovery information retaining section 170 is a memory that retains the recovery information indicating that the own IoT device 100 is the recovery target. The recovery information retaining section 170 has its security managed by the security managing section 160 as described above.

Once the recovery detecting section 150 detects that the own IoT device 100 has become recoverable, with the recovery information retained by the recovery information retaining section 170, the recovery reporting section 180 reports the recovery information to the outside.

The transmitting section 190 transmits the measurement results of the sensor 120 to the outside by wireless communication. It is to be noted that when the recovery detecting section 150 detects that the own IoT device 100 has become recoverable, the transmitting section 190 stops transmitting the measurement results.

[Recovery Detection]

The recovery detecting section 150 detects that the own IoT device 100 has become recoverable by sensing the occurrence of a predetermined event. The predetermined event may conceivably be the receipt of the discard signal from an external apparatus such as the sensor 120, or the sensing by the IoT device 100 of its own failure.

The conceivable cases in which the IoT device 100 senses its own failure include when the measurement results (sensing data) from the sensor 120 reveal values that differ from those of normal times or are abnormally different from those of nearby IoT devices 100. Another conceivable case is one in which the IoT device 100 has sensed the expiration of its service life.

Specifically, there may conceivably be cases in which the own IoT device 100 has temperatures abnormally higher than those of nearby IoT devices 100 or in which the machine incorporating the IoT device 100 manifests a velocity inconceivable during normal operating times. Also, in a case where a camera of a surveillance system during monitoring operation fails to image the target, the IoT device 100 in that camera may determine that its deployed position has deviated and thereby detect a failure. In another case where farm animals such as cows wear IoT devices, the absence of movement detected by an IoT device 100 may be interpreted as a failure involving either the IoT device being detached from the animal or the position sensing section 130 being defective.

[Recovery Information]

The recovery information retained by the recovery information retaining section 170 may, for example, be a bit flag that is set to “0” indicating a normal use state or to “1” indicating a recoverable state.

At the time the recovery detecting section 150 has sensed the occurrence of a predetermined event, the time (timestamp) indicated by the clocking section 140 may be recorded as the recovery information. The timestamp records permit retroactive failure detection. That is, comparing the sensing data before writing of the recovery information with the sensing data thereafter permits investigation of the circumstances in which the failure occurred.

As will be discussed later, in a case where the IoT device 100 with no recovery information recorded therein (i.e., the device has yet to be recoverable) is fraudulently dismounted, the recovery reporting section 180, transmitting section 190, or some other suitable unit may be configured to issue a warning.

[Recovery Information Security Feature]

Writing of information to the recovery information retaining section 170 is secured to a certain extent by the security managing section 160 performing security management.

At the time the IoT device 100 itself has sensed a failure and writes the recovery information, a secure boot feature of the security managing section 160 imposes restrictions such that only legitimate (trustworthy) software is allowed to perform the writing. At this point, the IoT device 100 signs the recovery information using a key securely held therein in order to prevent falsification of the recovery information.

Meanwhile, in a case where the server 500 has sensed a failure of an IoT device 100 and transmits the discard signal to that device, the server 500 is authenticated through public key authentication, for example. Further, falsification of the recovery information is prevented by signing the recovery information using a secret key on the side of the server 500.

Moreover, the security managing section 160 has the anti-rollback function that senses fraudulent deletion of the recovery information written to the recovery information retaining section 170, thereby preventing falsification (deletion) of the recovery information.

[Reporting of the Recovery Information]

In order to report the recovery information to the outside, the recovery reporting section 180 may use radio waves, light (visible light, infrared rays, ultraviolet rays), sounds, ultrasonic waves, vibration, odor, or a change in the shape of the IoT device 100. That is, the recovery information is conceivably transmitted together with the measurement results of the sensor to the server 500 using typically radio waves. Preferably, the recovery information may be independently reported by some other suitable method.

The recovery information thus reported is detected by an event agent of the IoT devices 100 or of the system using these devices. There may be a case, however, where a third party is requested directly or indirectly by the event agent to performs the detection.

The recovery information is conceivably detected in radio waves by the base station 300 or remotely by the server 500 connected with the base station 300. In this case, the server 500 acts as a recovering apparatus. However, it is also possible to detect the recovery information on the basis of radio waves or light near the deployed positions of the devices using the above-mentioned terminal 200 or like apparatus. In this case, the terminal 200 acts as a recovering apparatus. In a largescale system, a helicopter equipped with the terminal 200 or like apparatus may conceivably search for recoverable devices.

It is also conceivable that the recoverable state is sensed without retention of the above-described explicit recovery information. That is, state transitions on the side that receives the measurement results sent from the IoT devices 100 may be interpreted as implicit recovery information for sensing the recoverable state. For example, in a case where continuously increasing temperature measurements allow prediction of an impending failed state, the recoverable state may be determined implicitly without recourse to the explicit recovery information.

[Fraudulent Recovery]

There is fear that where the IoT devices 100 are being deployed and operated continuously, they may be fraudulently recovered. In particular, in the case where deposits, to be discussed later, are made with respect to the devices, what is called premature harvesting may occur for the purpose of getting reimbursed dishonestly. Such fraudulent recovery is prevented using the recovery information explained above.

In order to prevent the premature harvesting, it is preferred that the information regarding the IoT devices 100 to be recovered not be disclosed. Concealing the information makes it impossible for those intent on the fraudulent recovery to find out where the IoT devices 100 are deployed in the first place. Furthermore, if the IoT devices 100 with respect to which deposits have been made are not known, it does not pay to randomly recover the devices. In this case, after it is determined to start recovering the IoT devices 100, arrangements are made to obtain the information for where to find these devices (e.g., obtain their position information).

Further, it is useful to install a feature that issues a warning against attempts to recover an IoT device 100 that does not retain the recovery information indicating that the device is recoverable. The warning may be issued in the form of sound alert or a warning report to the server 500, for example.

Furthermore, using the recovery information as discussed above permits retroactive detection of premature recovery. That is, inspecting the sensing data sent before and after writing of the recovery information makes it possible to determine whether or not premature harvesting was committed. For example, in a case in which the recovery information is found to have been written at a place where the device was not supposed to be deployed, there is conceivably a possibility that the device was prematurely recovered.

Also, in a case where deposits are assumed to have been made as will be discussed later, measures may conceivably be taken to refuse to reimburse the deposits with respect to the devices that have been prematurely harvested.

In addition, measures may conceivably be taken to impose fines on, or to rescind the permit of, a recovery operator involved in the premature harvesting.

<2. Operations>

[Writing and Verification of the Recovery Information]

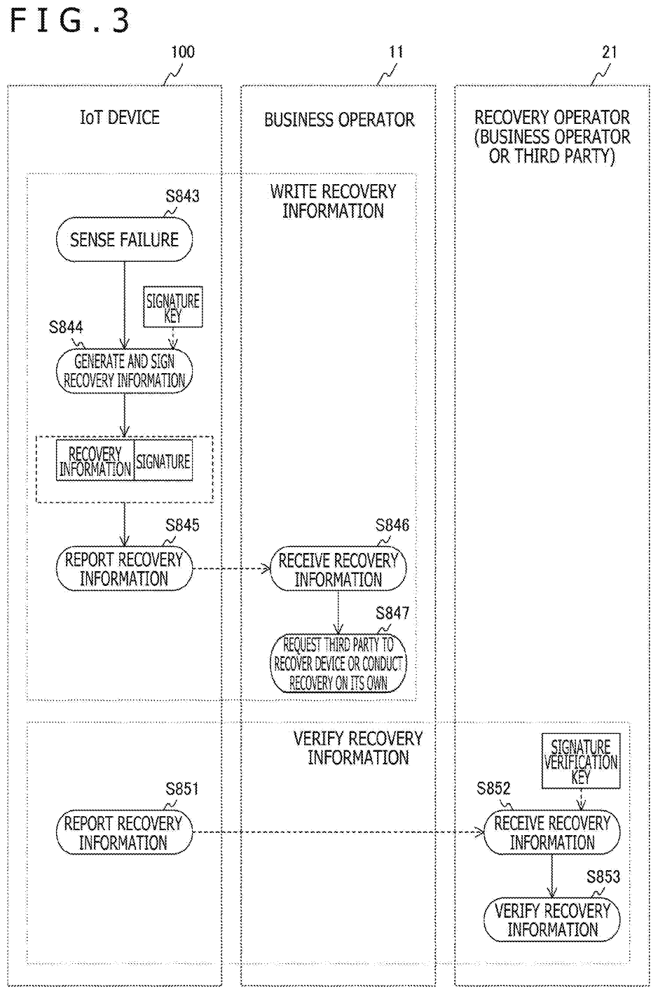

FIG. 3 is a view depicting a first operation example of writing and verifying the recovery information with the embodiment of the present technology.

In the first operation example, the recovery detecting section 150 in an IoT device 100 is assumed to have sensed a failure on the basis of the measurement results of the sensor 120. In this case, the recovery information is written in the following steps.

First, the recovery detecting section 150 senses a failure (step S843). The security managing section 160 then signs recovery information using a signature key of a business operator 11 dealing in the IoT device 100, before writing the recovery information to the recovery information retaining section 170 (step S844). The recovery reporting section 180 reports the recovery information to the outside (step S845).

The business operator 11 of the IoT device 100 receives the recovery information reported from the server 500 or from the terminal 200 (step S846). The business operator 11 then requests a third party to recover the IoT device 100 (step S847). Alternatively, the business operator 11 may recover the IoT device 100 on its own instead of requesting the third party to conduct the recovery.

The recovery information is verified in the steps below. It is assumed that the recovery reporting section 180 continuously reports the recovery information (step S851).

A recovery operator 21 is either a third party requested by the business operator 11 to do the recovery or the business operator 11 itself. The recovery operator 21 receives the recovery information reported from the server 500 or from the terminal 200 (step S852). Using a signature verification key of the business operator 11, the recovery operator 21 verifies the recovery information regarding the IoT device 100 (step S853). In the case where the recovery information is found not to have been falsified as a result of the verification, the recovery operator 21 recovers the IoT device 100. Incidentally, step S852 is an example of the recovery information receiving section and step S853 is an example of the recovery information verifying section, both sections being described in the appended claims.

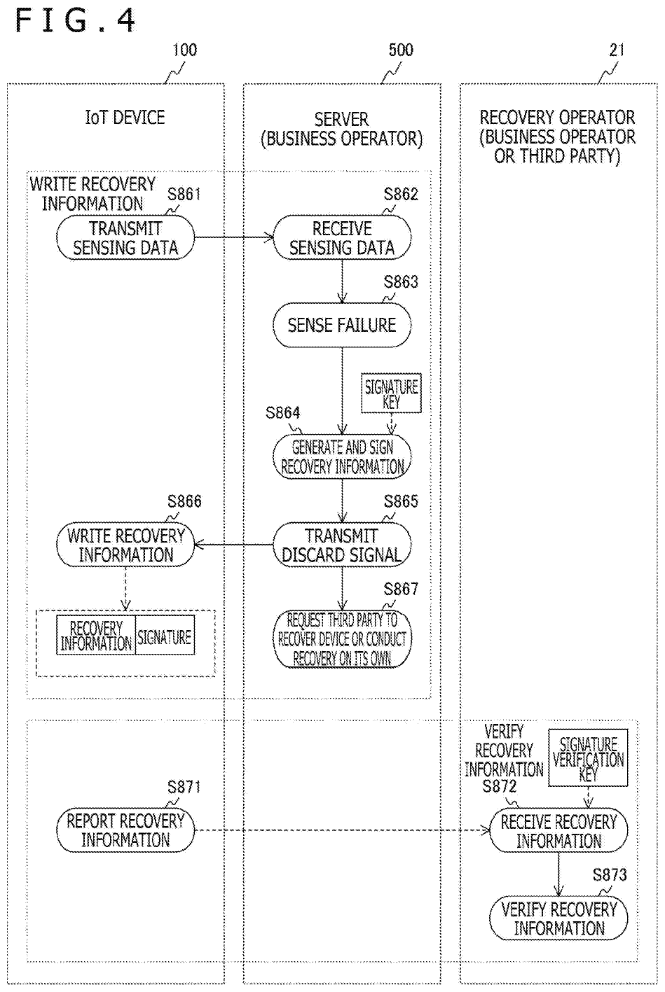

FIG. 4 is a view depicting a second operation example of writing and verifying the recovery information with the embodiment of the present technology.

In the second operation example, the server 500 of the business operator 11 is assumed to have sensed a failure on the basis of the measurement results of the sensor 120 in an IoT device 100. In this case, the recovery information is written in the steps described below.

First, the transmitting section 190 in the IoT device 100 transmits the measurement results (sensing data) from the sensor 120 (step S861). The server 500 receives the transmitted measurement results (step S862). Upon sensing a failure on the basis of the measurement results (step S863), the server 500 generates recovery information and signs it using a signature key (step S864). The server 500 then transmits the signed recovery information as a discard signal to the IoT device 100 (step S865). Incidentally, step S862 is an example of the measurement result receiving section and step S865 is an example of the discard signal transmitting section, both sections being described in the appended claims.

The IoT device 100 having received the discard signal from the server 500 writes the recovery information signed by the server 500 to the recovery information retaining section 170 via the security managing section 160 (step S866).

Meanwhile, the business operator 11 requests the third party to recover the IoT device 100 (step S867).

The recovery information is verified in the steps below. The recovery reporting section 180 reports the recovery information signed by the server 500 to the outside (step S871).

The recovery operator 21 is either the third party requested by the business operator 11 to perform the recovery or the business operator 11 itself. The recovery operator 21 receives the recovery information reported from the server 500 or from the terminal 200 (step S872). Using the signature verification key of the server 500, the recovery operator 21 verifies the recovery information regarding the IoT device 100 (step S873). In the case where the recovery information is found not to have been falsified as a result of the verification, the recovery operator 21 recovers the IoT device 100. Incidentally, step S872 is an example of the recovery information receiving section and step S873 is an example of the recovery information verifying section, both sections being described in the appended claims.

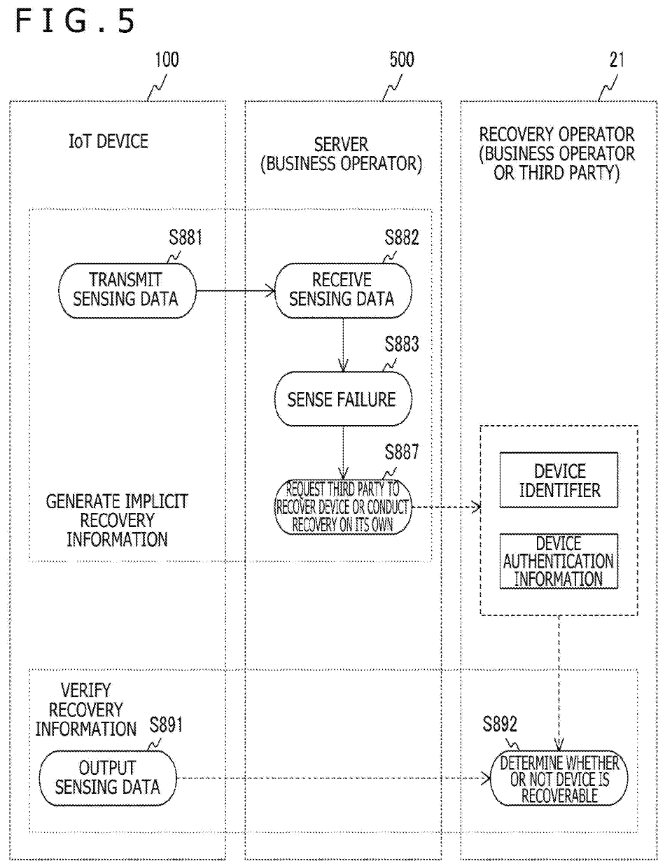

FIG. 5 is a view depicting a third operation example of writing and verifying the recovery information with the embodiment of the present technology.

In the third operation example, the server 500 of the business operator 11 is assumed to have sensed a failure on the basis of the measurement results of the sensor 120 in an IoT device 100 and, without writing any recovery information subsequently to the IoT device 100, handles the measurement results as implicit recovery information. In this case, the implicit recovery information is generated in the steps below.

First, the transmitting section 190 in the IoT device 100 transmits the measurement results (sensing data) from the sensor 120 (step S881). The server 500 receives the transmitted measurement results (step S882). Upon sensing a failure on the basis of the measurement results (step S883), the server 500 generates information regarding the IoT device 100. The generated information regarding the IoT device 100 is a list of the device targeted for recovery. The list includes a device identifier identifying the IoT device 100 and device authentication information. The device authentication information is information for authenticating the IoT device 100 and is normally known only to the base station 300 and to the server 500 of the business operator 11.

The business operator 11 then requests the third party to recover the IoT device 100 (step S887). Alternatively, the business operator 11 may recover the IoT device 100 on its own instead of requesting the third party to carry out the recovery.

The recovery information is verified in the steps below. It is assumed that the transmitting section 190 continuously transmits the measurement results (step S891). The recovery operator 21 receives the transmitted measurement results via the server 500 or via the terminal 200, and acquires the device identifier of the IoT device 100. The recovery operator 21 then determines whether or not the device is recoverable on the basis of the list of the device targeted for recovery (step S892).

<3. Deposits>

What follows is an explanation of a deposit-based process as one method of promoting the recovery of the IoT devices 100.

[Types of Deposits]

The incentive for implementing deposits comes conceivably in two forms that are money, and a limit on the number of deployed devices.

In the case where the deposit is implemented in the form of money, a conceivable scenario is that a predetermined amount of money is deposited at the time an IoT device 100 is deployed and is returned when the device is recovered. On the other hand, in the case where the deposit is implemented as the limit on the number of devices, a conceivable scenario is that an upper limit is set on the number of deployable device for each business operator in consideration of radio wave resources and the environment and that new devices are not allowed to be deployed unless the existing ones are recovered.

[Types of Deposit Operators]

A third party deposit operator is conceivable in addition to the device business operator also acting as the deposit operator.

In the case where the third party deposit operator is utilized, the device business operator registers the recovery target devices with the deposit operator. In the case where the deposit is implemented as money, registration fees are paid to the deposit operator. At the time of the recovery, the fees minus the deposit paid to the operator that has recovered the devices are returned. In this case, the registration may be made mandatory in consideration of radio wave resources and the environment.

On the other hand, in the case where the device business operator itself performs the recovery, it is conceivable not to implement monetary deposits but to circumvent the upper limit on the number of deployable devices. In the latter case, a third party recovery operator may be requested to act as a proxy in order to reduce recovery costs. The recovery operator is paid for the recovered devices.

[Recovery Request]

In the process involving the deposits, a third party may also be requested to recover an IoT device 100 of which the recovery flag has been detected. At the time of the request, it is allowed to disclose the information regarding the deployed position of the IoT device 100 (e.g., position information), the method of recovering the device, and the information regarding the IoT device 100 itself (e.g., device shape).

[Recovery Operator]

The business operator may perform the recovery using the information it retains regarding the IoT devices 100 targeted for recovery. In a case where the business operator requests the third party to carry out the recovery, the third party may recover the devices using the disclosed information.

The determination of whether or not a given device is recoverable is made in a manner similar to that of the case where recourse to the above-described deposits is not assumed.

[Operation Examples]

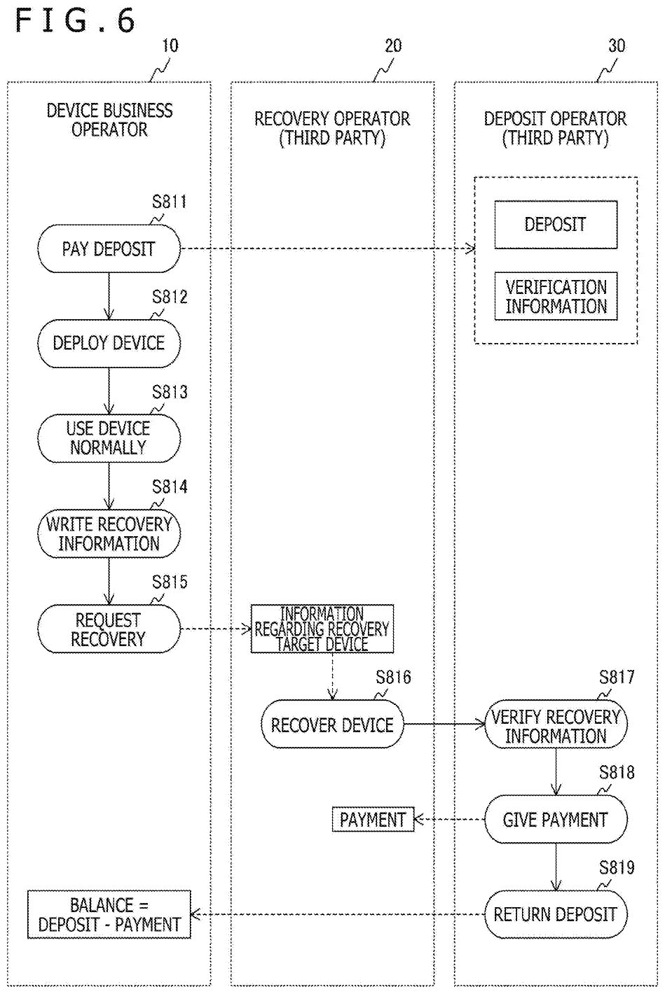

FIG. 6 is a view depicting a first operation example of a process using deposits with the embodiment of the present technology.

In the first operation example, three parties including a business operator 10 of the IoT devices 100, a recovery operator 20, and a deposit operator 30 are assumed.

When deploying an IoT device 100, the business operator 10 dealing in the IoT device 100 pays a deposit to the deposit operator 30 in advance (step S811). At this point, verification information for verifying the recovery information is also registered with the deposit operator 30.

The business operator 10 deploys the IoT device 100 (step S812), and uses the deployed IoT device 100 in normal operation (step S813). When the recovery detecting section 150 senses the occurrence of a predetermined event, the security managing section 160 writes the recovery information to the recovery information retaining section 170 (step S814). The business operator 10 then requests the recovery operator 20 to recover the IoT device 100 (step S815). At this point, the information regarding the IoT device 100 targeted for recovery is conveyed to the recovery operator 20.

When requested to do the recovery, the recovery operator 20 recovers the IoT device on the basis of the information regarding the IoT device 100 targeted for recovery (step S816). The recovery operator 20 carries the recovered IoT device 100 to the deposit operator 30.

Upon receipt of the recovered IoT device 100, the deposit operator 30 verifies the recovery information of the IoT device 100 on the basis of previously registered verification information (step S817). In a case where the recovery information is found not to have been falsified as a result of the verification, the deposit operator 30 gives a payment to the recovery operator 20 (step S818). At the same time, the deposit operator 30 returns to the business operator 10 the deposit minus the payment given to the recovery operator 20 (step S819).

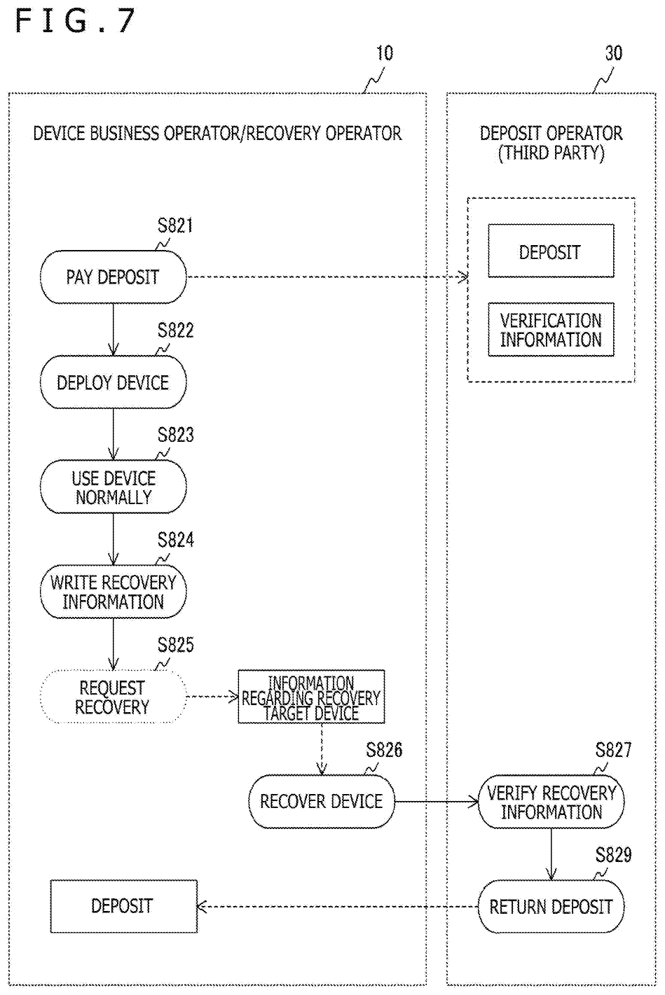

FIG. 7 is a view depicting a second operation example of the process using deposits with the embodiment of the present technology.

In the second operation example, the business operator 10 dealing in the IoT device 100 is assumed to conduct the recovery. The process ranging from payment of the deposit (step S821) to writing of the recovery information (step S824) is similar to that of the above-described first operation example (step S811 to step S814).

However, the business operator 10 does not request a third party to recover the IoT device 100 (step S825). Instead, it is the business operator 10 that recovers the IoT device 100 (step S826) and carries the recovered device to the deposit operator 30.

Upon receipt of the recovered IoT device 100, the deposit operator 30 verifies the recovery information of the IoT device 100 on the basis of the previously registered verification information (step S827). In a case where the recovery information is found not to have been falsified as a result of the verification, the deposit operator 30 returns the deposit to the business operator 10 (step S829).

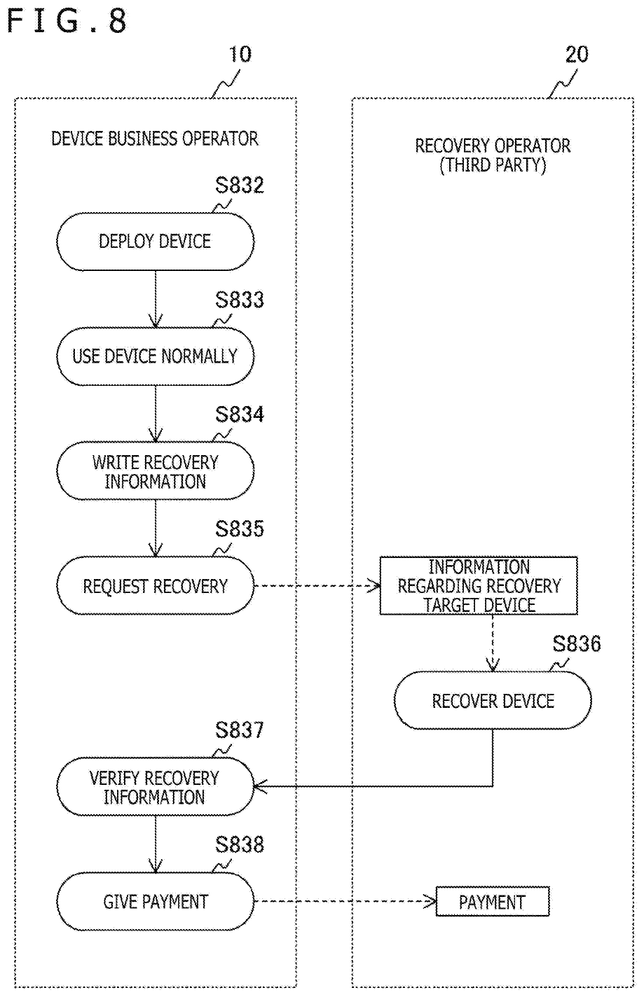

FIG. 8 is a view depicting a third operation example of the process using deposits with the embodiment of the present technology.

In the third operation example, the incentive for recovering the IoT devices 100 is not the monetary deposit but the upper limit on the number of the deployed devices.

The business operator 10 deploys an IoT device 100 without paying a deposit thereof (step S832). The business operator 10 then uses the IoT device 100 in normal operation (step S833). When the recovery detecting section 150 senses a predetermined event, the security managing section 160 writes the recovery information to the recovery information retaining section 170 (step S834). The business operator 10 proceeds to request the recovery operator 20 to recover the IoT device 100 (step S835). At the time of the request, the information regarding the IoT device 100 targeted for recovery is conveyed to the recovery operator 20.

When requested to perform the recovery, the recovery operator 20 recovers the IoT device 100 on the basis of the information regarding the recovery target device (step S836), and returns the recovered IoT device 100 to the business operator 10.

Upon receipt of the recovered IoT device 100, the business operator 10 verifies the recovery information in the IoT device 100 on the basis of the verification information retained by the business operator 10 (step S837). In the case where the recovery information is found not to have been falsified as a result of the verification, the business operator 10 gives a payment to the recovery operator 20 (step S838).

According to the above-described embodiment of the present technology, the IoT devices 100 each retain the recovery information indicating that the device is recoverable. Reporting the recovery information to the outside promotes recovery of the deployed IoT devices 100 that are no longer needed.

The embodiment described above is merely an example in which the present technology may be implemented. The particulars of the embodiment correspond basically to the inventive matters claimed in the appended claims. Likewise, the inventive matters named in the appended claims correspond basically to the particulars of the embodiment with the same names in the foregoing description of the embodiment. However, the embodiment and other examples are not limitative of the present technology that may also be implemented using various modifications and alterations of the embodiment so far as they are within the scope of the appended claims.

The procedures discussed above in connection with the embodiment may be construed as constituting a method involving a series of such procedures. Also, the procedures may be construed as forming a program for causing a computer to execute a series of such procedures, or as constituting a recording medium storing such a program. The recording medium may be a CD (Compact Disc), an MD (MiniDisc), a DVD (Digital Versatile Disc), a memory card, or a Blu-ray Disc (registered trade-mark), for example.

The advantageous effect stated in the description are only examples and are not limitative of the present technology. There may be additional advantageous effects derived from the description.

The present disclosure may be implemented preferably in the following configurations.

(1)

A sensing device including:

a sensor configured to measure a surrounding environment;

a sensing section configured to sense occurrence of a predetermined event;

a transmitting section configured to continuously transmit measurement results of the sensor until the occurrence of the predetermined event is sensed; and

a recovery reporting section configured such that when the occurrence of the predetermined event is sensed, the recovery reporting section reports recovery information indicating that the device is targeted for recovery.

(2)

The sensing device according to (1), in which

the sensing section senses the predetermined event upon receipt of a discard signal from another device.

(3)

The sensing device according to (1), in which

the sensing section senses the predetermined event on the basis of a change in an environment of the device.

(4)

The sensing device according to (3), in which

the sensing section senses the change in the environment of the device on the basis of measurement results of the sensor.

(5)

The sensing device according to any one of (1) to (4), further including:

a recovery information retaining section configured to retain the recovery information.

(6)

The sensing device according to (5), further including: a security managing section configured to perform secure writing to the recovery information retaining section.

(7)

The sensing device according to (6), in which

the security managing section writes the recovery information signed with a signature key to the recovery information retaining section.

(8)

The sensing device according to any one of (5) to (7), further including:

a clocking section configured to clock the time, in which

the recovery information retaining section retains the clocked time as the recovery information.

(9)

The sensing device according to any one of (1) to (8), further including:

a position sensing section configured to sense the position of the device, in which

the transmitting section transmits the position sensed by the position sensing section together with the measurement results of the sensor.

(10)

The sensing device according to any one of (1) to (9), in which

the recovery reporting section reports the recovery information signed with the signature key.

(11)

A recovering apparatus including:

a recovery information receiving section configured to receive from a sensing device a report of recovery information indicating that the sensing device is targeted for recovery; and

a recovery information verifying section configured to verify that the recovery information has not been falsified by use of a signature verification key.

(12)

A discarding apparatus including:

a measurement result receiving section configured to receive measurement results of a sensor transmitted from a sensing device; and

a discard signal transmitting section configured to transmit a discard signal identifying the sensing device as a recovery target upon sensing a change in an environment of the sensing device on the basis of the measurement results.

### REFERENCE SIGNS LIST

10, 11 Business operator
20, 21 Recovery operator
30 Deposit operator
100 IoT device
110 Receiving section
120 Sensor
130 Position sensing section
140 Clocking section
150 Recovery detecting section
160 Security managing section
170 Recovery information retaining section
180 Recovery reporting section
190 Transmitting section
200 Terminal
300 Base station
350 Gateway device
400 Network
500 Server

1. A sensing device comprising:
a sensor configured to measure a surrounding environment;
a sensing section configured to sense occurrence of a predetermined event;
a transmitting section configured to continuously transmit measurement results of the sensor until the occurrence of the predetermined event is sensed; and
a recovery reporting section configured such that when the occurrence of the predetermined event is sensed, the recovery reporting section reports recovery information indicating that the device is targeted for recovery.

2. The sensing device according to claim 1, wherein
the sensing section senses the predetermined event upon receipt of a discard signal from another device.

3. The sensing device according to claim 1, wherein
the sensing section senses the predetermined event on a basis of a change in an environment of the device.

4. The sensing device according to claim 3, wherein
the sensing section senses the change in the environment of the device on a basis of measurement results of the sensor.

5. The sensing device according to claim 1, further comprising:
a recovery information retaining section configured to retain the recovery information.

6. The sensing device according to claim 5, further comprising:
a security managing section configured to perform secure writing to the recovery information retaining section.

7. The sensing device according to claim 6, wherein
the security managing section writes the recovery information signed with a signature key to the recovery information retaining section.

8. The sensing device according to claim 5, further comprising:
a clocking section configured to clock the time, wherein
the recovery information retaining section retains the clocked time as the recovery information.

9. The sensing device according to claim 1, further comprising:
a position sensing section configured to sense the position of the device, wherein
the transmitting section transmits the position sensed by the position sensing section together with the measurement results of the sensor.

10. The sensing device according to claim 1, wherein
the recovery reporting section reports the recovery information signed with the signature key.

11. A recovering apparatus comprising:
a recovery information receiving section configured to receive from a sensing device a report of recovery information indicating that the sensing device is targeted for recovery; and
a recovery information verifying section configured to verify that the recovery information has not been falsified by use of a signature verification key.

12. A discarding apparatus comprising:
a measurement result receiving section configured to receive measurement results of a sensor transmitted from a sensing device; and
a discard signal transmitting section configured to transmit a discard signal identifying the sensing device as a recovery target upon sensing a change in an environment of the sensing device on a basis of the measurement results.
